(19) United States
(12) Patent Application Publication
(10) Pub. No.: US 2007/0186416 A1
(43) Pub. Date: Aug. 16, 2007

(54) Component repair process

(76) Inventors: Jens Birkner, Oberhausen (DE); Winfried Esser, Bochum (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/656,788

(22) Filed: Jan. 23, 2007

(30) Foreign Application Priority Data
Jan. 24, 2006 (EP) 06001466.9

(51) Int. Cl. B23P 6/00; B29C 73/00

(52) U.S. Cl. 29/889.1; 29/402.01

(57) ABSTRACT

Component repair process, in which a loss of wall thickness is repaired just by a standard coating, results in a component with a layer which has properties that are less than optimum in the repaired region at elevated temperatures. The process according to the invention includes a plastic deformation and heat treatment of the layer, so that it is converted into a coarse-grained microstructure.

### CROSS REFERENCE TO RELATED APPLICATIONS

This application claims priority of European application No. 06001466.9 filed Jan. 24, 2006, which is incorporated by reference herein in its entirety.

### FIELD OF INVENTION

The invention relates to a component repair process, in accordance with the claims.

### BACKGROUND OF THE INVENTION

Hollow components, such as for example components of a gas turbine, e.g. rotor blades or guide vanes, which have suffered a loss of wall thickness, in particular locally, as a result of oxidation, high temperature corrosion, etc. in use, are repaired by material being sprayed on. The powder for the layer is applied by means of plasma spraying (VPS: vacuum plasma spraying) or high-velocity oxyfuel (HVOF) spraying. On account of its fine microstructure, i.e. very small grain sizes, this layer only has strength properties which match the base material of the component at low temperatures of use up to approx. 500° C. Above 500° C., the mechanical strength of the material in the repaired region drops considerably. This is due to the very fine microstructure of the coating, which permits the particle/grain boundaries to slide at relatively high temperatures.

Alternative known processes include welding or soldering processes, but these have the known drawbacks such as hot cracking, the formation of brittle phases, etc.

### SUMMARY OF INVENTION

Therefore, it is an object of the invention to provide a process which avoids the above problem.

The object is achieved by the component repair process as claimed in the claims.

The advantage lies in the boost to the grain growth in a layer resulting from the deliberate, prior introduction of residual stresses into this layer.

The measures listed in the subclaims can be combined with one another in any desired way in order to achieve further advantages.

### BRIEF DESCRIPTION OF THE DRAWINGS

The invention is explained in more detail with reference to the drawings, in which:

FIG. 1 diagrammatically depicts the sequence of the process according to the invention,

FIG. 2 shows a list of superalloys,

FIG. 3 shows a gas turbine,

FIG. 4 shows a perspective view of a turbine blade or vane, and

FIG. 5 shows a perspective view of a combustion chamber.

### DETAILED DESCRIPTION OF INVENTION

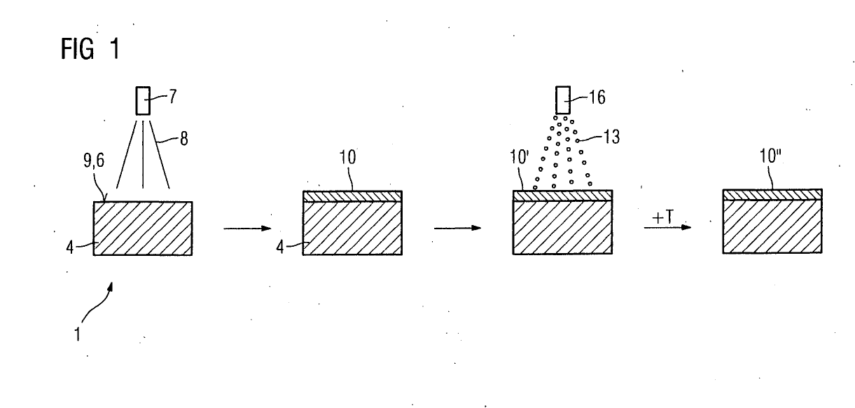

FIG. 1 diagrammatically depicts the sequence of the process according to the invention.

The component 1 which is to be repaired, i.e. the wall thickness of which is to be increased, comprises a substrate 4 with a surface 5.

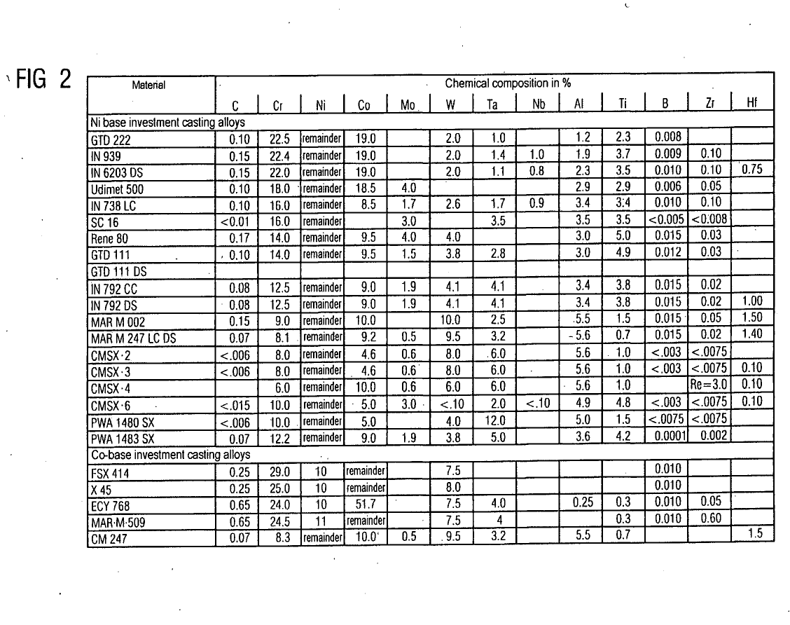

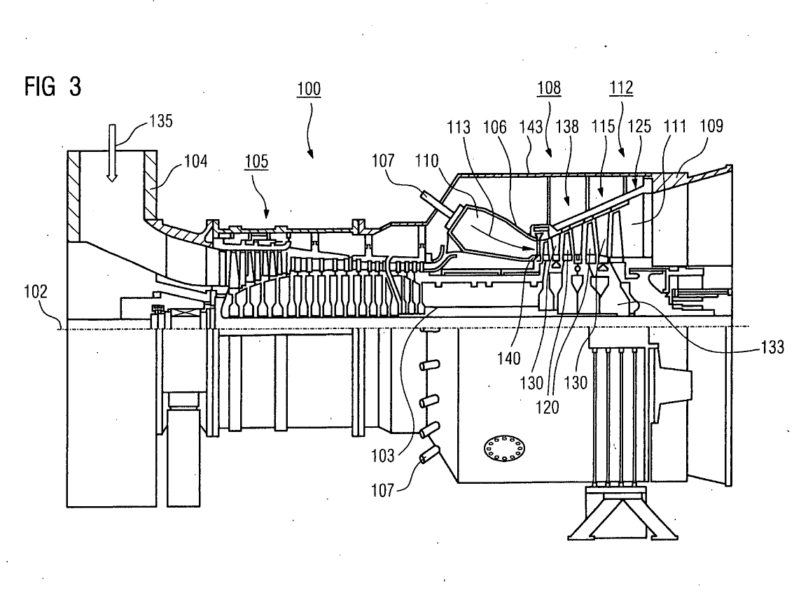

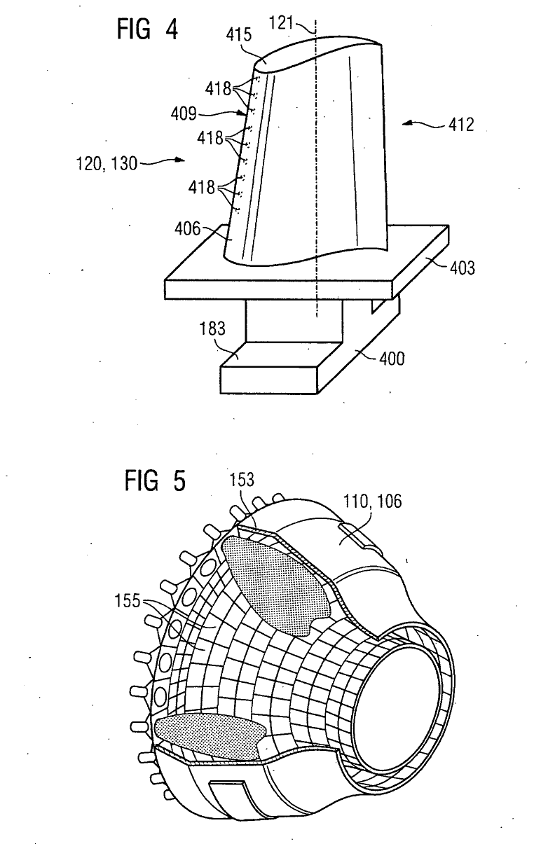

The substrate 4, in particular in the case of components for high-temperature applications, such as for example gas turbines 100 (FIG. 3), in particular in the case of turbine blades or vanes 120, 130 (FIG. 4) or combustion chamber elements 155 (FIG. 5) consists of nickel-base or cobalt-base superalloys (FIG. 2).

In the first process step, the surface 6 that is to be repaired can be prepared, i.e. oxides or other impurities can be removed and/or it can preferably also be made more even by machining, for example by being converted into a recess of uniform depth. The surface 6 that is to be repaired is preferably only part of the overall surface 5 of the substrate 4. The process therefore preferably represents a local repair process.

Then, material 8, originating for example from a plasma nozzle or an ingot used in an electron beam physical vapor deposition installation, etc. is applied to the surface 6. Other forms of application (VPS, HVOF, cold spraying) are also possible. The material 8 preferably has an identical composition to the material of the substrate 4. It is preferable to select a similar composition for the material 8 to the composition of the substrate 4, i.e. the concentrations of the individual elements in the alloy deviate to an extent of at least 1% and at most 10% to 20%, and all the elements of the substrate 4 are present in the material 8, possibly apart from those which form <1 wt % in the substrate 4. Further elements may also be present.

Alternatively, an MCrAlX alloy, which is described in more detail below, is used for the material 8.

Following the coating process as one of the first process steps according to the invention, a layer 10 has been formed on the substrate 4, but this layer has a fine microstructure (particularly <1 μm) i.e. the grain sizes are up to 10 times, in particular 100 times, smaller than the grain sizes in the substrate 4, with the drawbacks described above.

In a further step of the process according to the invention, residual mechanical stresses are introduced into this layer 10, preferably by plastic deformation. This can be done by shot peening, in which case shot 13 is diverted from a shot-peening nozzle 16 on to the surface 10 of the substrate 4, or by rolling. Other processes for introducing plastic deformations, such as, for example, a laser treatment are also conceivable and may be combined with one another.

Following this plastic deformation, in one of the last steps of the process according to the invention, a suitable heat treatment, e.g. a solution anneal at a solution-annealing temperature of the substrate 4 is carried out on the layer 10′ which has been modified in this way, effecting recrystallization and then grain growth.

The heat treatment may also be carried out at a solution-annealing temperature or other typical heat treatment temperature (diffusion annealing) of the material 8 of the layer 10′.

This more coarse-grained microstructure of the layer 10″ has grain sizes of between 500 μm and 1000 μm, in particular around 1 mm, i.e. grain sizes in the millimeter range, and has the required strength at higher temperatures, and is comparable to the mechanical properties of the substrate 4.

It is then in turn possible for further layers to be applied to this layer 10″, for example a MCrAlX layer and/or a ceramic layer.

FIG. 3 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 110, are subject to the highest thermal stresses.

To be able to withstand the temperatures which prevail there, they have to be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 as well as a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy. The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have protective layers protecting against corrosion or oxidation (MCrAlX; M is at least one element selected from the group consisting of iron (Fe), cobalt (Co), nickel (Ni), X is an active element and represents yttrium (Y) and/or silicon and/or at least one rare earth element, or haffiium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer).

It is also possible for a thermal barrier coating, which is preferably the outermost layer and consists, for example, of ZrO₂, Y₂O₃-ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may have grains which are porous, are provided with microcracks or are provided with macrocracks, to improve the resistance to thermal shocks. It is preferable for the thermal barrier coating to be more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of a gas turbine 100. The combustion chamber 110 is configured, for example, as what is known as an annular combustion chamber, in which a multiplicity of burners 107, which generate flames 156, arranged circumferentially around the axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

A cooling system may also be provided for the heat shield elements 155 and/or their holding elements, on account of the high temperatures in the interior of the combustion chamber 110. The heat shield elements 155 are in this case, for example hollow and may also have cooling holes (not shown) which open out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example made from MCrAlX: M is at least one element selected from the group consisting of iron (Fe), cobalt (Co), Nickel (Ni), X is an active element and represents yttrium (Y) and/or silicon and/or at least one rare earth element or hafnium (Hf). Alloys of this type are known from EP 0486489 B1, EP 0786017 B1, EP 0412397 B1 or EP 1 306454 A1, which are intended to form part of the present disclosure with regard to the chemical composition of the alloy.

A ceramic thermal barrier coating, consisting for example of ZrO₂, Y₂O₃-ZrO₂, i.e. unstabilized, partially stabilized or fully stabilized by yttrium oxide and/or calcium oxide, and/or magnesium oxide, may also be present on the MCrAlX.

Columnar grains are produced in the thermal barrier coating by suitable coating processes, such as for example electron beam physical vapor deposition (EB-PVD).

Other coating processes are conceivable, for example atmospheric plasma spraying (APS), LPPS, VPS or CVD. The thermal barrier coating may have grains which are porous, are provided with microcracks or are provided with macrocracks, in order to improve the resistance to thermal shocks.

Refurbishment means that after they have been used, protective layers may have to be removed from turbo blades or vanes 120, 130, heat shield elements 155 (e.g. by sand-blasting). Then, the corrosion and/or oxidation layers and products are removed. If appropriate, cracks in the turbine blade or vane 120, 130 or the heat shield element 155 are also repaired. Then, the repair process according to the invention is carried out in order to restore a predetermined wall thickness. Finally, the turbine blades or vanes 120, 130, heat shield elements 155 are recoated and the turbine blades or vanes 120, 130 or the heat shield elements 155 are reused.

1-9. (canceled)

10. A component repair process, comprising:
applying a material for a layer to a surface of a component substrate to increase a wall thickness of the substrate where the material of the layer is similar to a material of the substrate;
producing residual stresses in the layer by plastic deformation of the layer; and
heat treating the component to producing a more coarse-grained microstructure of the layer.

11. The process as claimed in claim 10, wherein the residual stresses are produced in the layer by shot peening or laser irradiation.

12. The process as claimed in claim 11, wherein the heat treatment is a solution anneal heat treatment performed at a solution-annealing temperature of the substrate.

13. The process as claimed in claim 11, wherein the heat treatment is a solution anneal at a solution-annealing temperature or a heat treatment temperature of the material of the layer.

14. The process as claimed in claim 13, wherein grain sizes of the layer prior to the introduction of the residual stresses and prior to the heat treatment are at least 10 times smaller than grain sizes of the substrate.

15. The process as claimed in claim 14, wherein the grain sizes of the layer prior to the introduction of the residual stresses and prior to the heat treatment are at least 100 times smaller than the grain sizes of the substrate.

16. The process as claimed in claim 15, wherein the grain size of the layer after the heat treatment is approximately 1 mm.

17. The process as claimed in claim 16, wherein the component to be repaired is a turbine blade or a turbine vane.

18. The process as claimed in claim 17, wherein the layer is applied locally to a surface of the substrate of the component.

19. A turbine component repair process, comprising:
applying a material for a layer to a surface of a substrate of the component to increase a wall thickness of the substrate where the material of the layer is similar to a material of the substrate, wherein the layer is applied only locally to the substrate surface;
producing residual stresses in the layer by plastic deformation of the layer; and
heat treating the component to producing a more coarse-grained microstructure of the layer.
